(19) United States
(12) Patent Application Publication
(10) Pub. No.: US 2024/0028482 A1
(43) Pub. Date: Jan. 25, 2024

(54) LOAD BALANCING DURING BACKUP AND RESTORE

(71) Applicant: Dell Products L.P., Round Rock, TX (US)

(72) Inventors: Sunil Yadav, Bangalore (IN); Shelesh Chopra, Bangalore (IN); Preeti Varma, Bangalore (IN)

(21) Appl. No.: 17/872,641

(22) Filed: Jul. 25, 2022

(51) Int. Cl. G06F 11/14; G06F 21/62; G06F 11/30

(52) U.S. Cl. CPC G06F 11/1469; G06F 21/6218; G06F 11/3051

(57) ABSTRACT

One or more embodiments of the invention allows for a better method of choosing a data node for performing a data protection event such as a backup and/or restoration. The one or more embodiments of the invention allows a user or administrator to choose a preferred data node for performing the data protection event or has a data protection manager or similar component of a system dynamically choses a preferred data node for performing the data protection event based on predetermined criteria. Such predetermined criteria may include each data node's load and workload as well as the type of backup that will be or was performed. This will allow for a more efficient backup and/or restoration, while avoiding overloading and collisions.

### BACKGROUND

In an enterprise environment, clustering is frequently used. One version of clustering, failover clustering, allows for a plurality of nodes to work together to increase the availability and scalability of the nodes. If a failure occurs in one or more of the nodes, other nodes are able to provide the services of the failed nodes with minimum disruptions to the end users of the node(s). To prevent loss of important data, performing backups and restorations of the assets located on the plurality of nodes or other related computing devices is necessary. However, in a clustering system that includes shared storage, performing a backup and/or restoration becomes increasingly difficult.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a cluster environment in accordance with one or more embodiments of the invention.

FIG. 2A shows a flowchart of a method for performing a data protection event such as a backup and/or restoration in accordance with one or more embodiments of the invention.

FIG. 2B shows a flowchart of a method for performing a backup of a selected asset using a preferred data node in accordance with one or more embodiments of the invention.

FIG. 2C shows a flowchart of a method for performing a restoration of a selected asset using a preferred data node in accordance with one or more embodiments of the invention.

FIG. 2D shows a flowchart of a method for determining a preferred data node for use in the backup and/or restoration of the methods of FIGS. 2B and 2C in accordance with one or more embodiments of the invention.

FIG. 3 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to C. As used herein, the aforementioned labeling means that the element may include any number of items and does not require that the element include the same number of elements as any other item labeled as A to C. For example, a data structure may include a first element labeled as A and a second element labeled as C. This labeling convention means that the data structure may include any number of the elements. A second data structure, also labeled as A to C, may also include any number of elements. The number of elements of the first data structure and the number of elements of the second data structure may be the same or different.

In general, embodiments of the invention relate to a system and methods for managing data clusters. More specifically, embodiments of the invention relate to a method of performing at least one of a backup and restoration using a preferred data node to perform the at least one of the backup and restoration.

Generally, when a backup is triggered, an initial data node (also referred to a node) that the backup is triggered on or directed to, performs the backup and/or it coordinates it with another node. When a restoration is triggered, the original data node that performed the backup of the at least one selected asset, performs the restoration. However, in a cluster environment, in both cases, the data node that performs the data protection event (the backup and/or restoration) may not be the best or appropriate node to use. This may result in collisions and other problems that lead to a failure of the protection event. Further in the traditional method of performing a protection event in a cluster environment, there is no straightforward way for a user or administrator to specify which data node should perform the protection event.

One or more embodiments of the invention improve upon the traditional method of performing a backup and/or restore, by either allowing a user or administrator to choose a preferred data node for performing the data protection event, or by having a data protection manager or similar component of a system dynamically chooses a preferred data node for performing the data protection event based on predetermined criteria. Such predetermined criteria may include each data node's load and workload as well as the type of backup that will be or was performed. This will allow for a more efficient backup and/or restoration, while avoiding overloading and collisions.

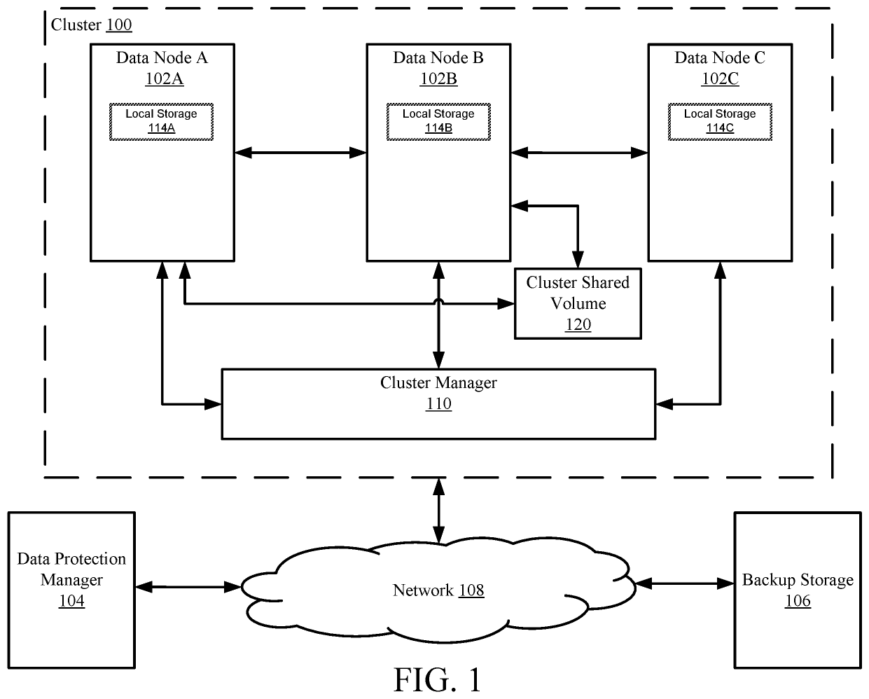

FIG. 1 shows a diagram of a system in accordance with one or more embodiments of the invention. The system may include a data protection manager (104), backup storage (106), and at least one data cluster (100). The system may include any number of data clusters (100) without departing from the invention. For example, the system may include two data clusters (not shown) that communicate through a network (108). The system may include additional, fewer, and/or other components without departing from the invention. Each of the components in the system may be operatively connected via any combination of wireless and/or wired networks (108).

In one or more embodiments of the invention, the data cluster (100) may include a plurality of nodes (e.g., 102A-102C), a cluster manager (110), and at least one cluster shared volume(s) (120). The system may include any number of data nodes (e.g., 102A-102C) without departing from the invention. For example, the system may include two data nodes (102A) and (102B) that communicate through an internal network or by other means. The system may include additional, fewer, and/or other components without departing from the invention. Each of the components of the data cluster may be operatively connected via any combination of wireless and/or wired networks (108).

In one or more embodiments of the invention, the data protection manager (104) includes the functionality to provide data protection services to the data cluster (100). The data protection manager (104) may include the functionality to provide and/or obtain other and/or additional services without departing from the invention. While FIG. 1 shows the data protection manager (104) as a separate component, it may be a part of the cluster manager (110) or located in one or more of the data nodes (e.g., 102A-102C).

To perform the aforementioned data protection services, the data protection manager (104) may include various modules such as a mapping module (not shown). The data protection manager (104) may also include persistent storage (not shown), or it may store data on one or more of the local storage devices (114A-114C) that are associated with the data nodes (e.g., 102A-102C). Alternatively, the data protection manager (104) may store data on the cluster shared volumes (e.g., 120). The data protection manager (104) may include other and/or additional components without departing from the invention. Each of the aforementioned components of the data protection manager is discussed below.

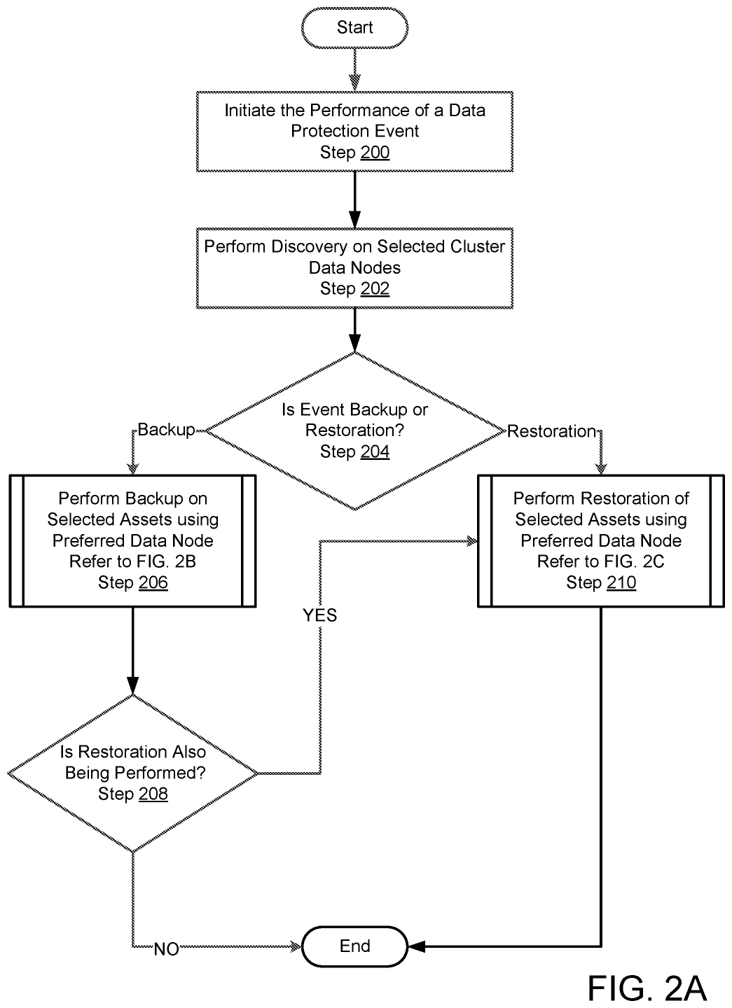

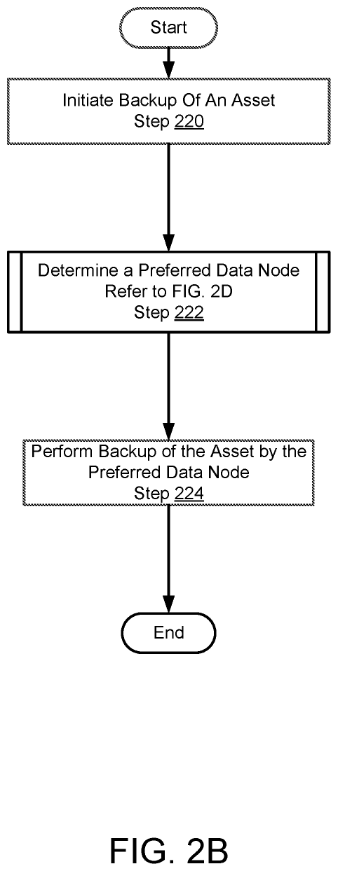

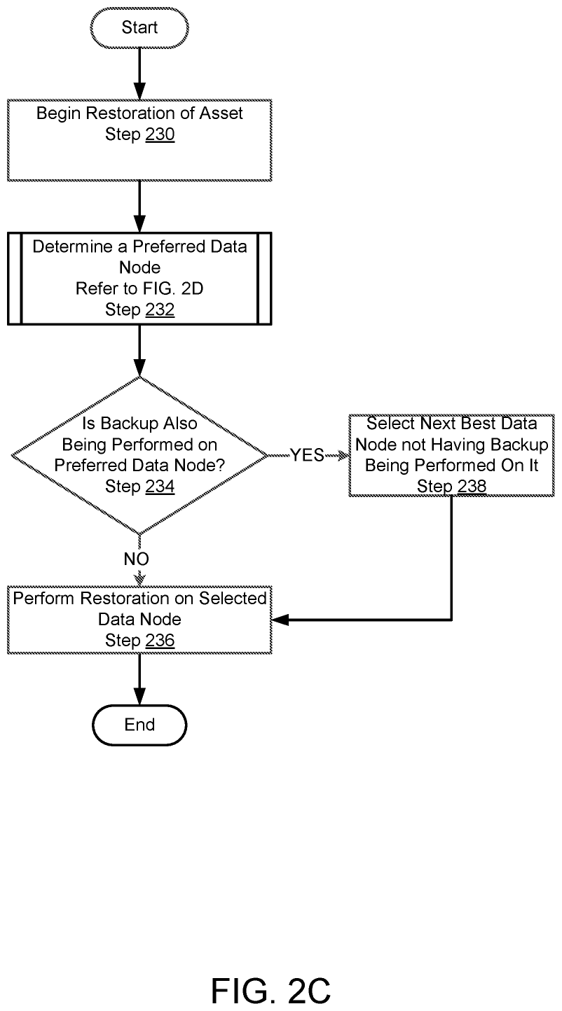

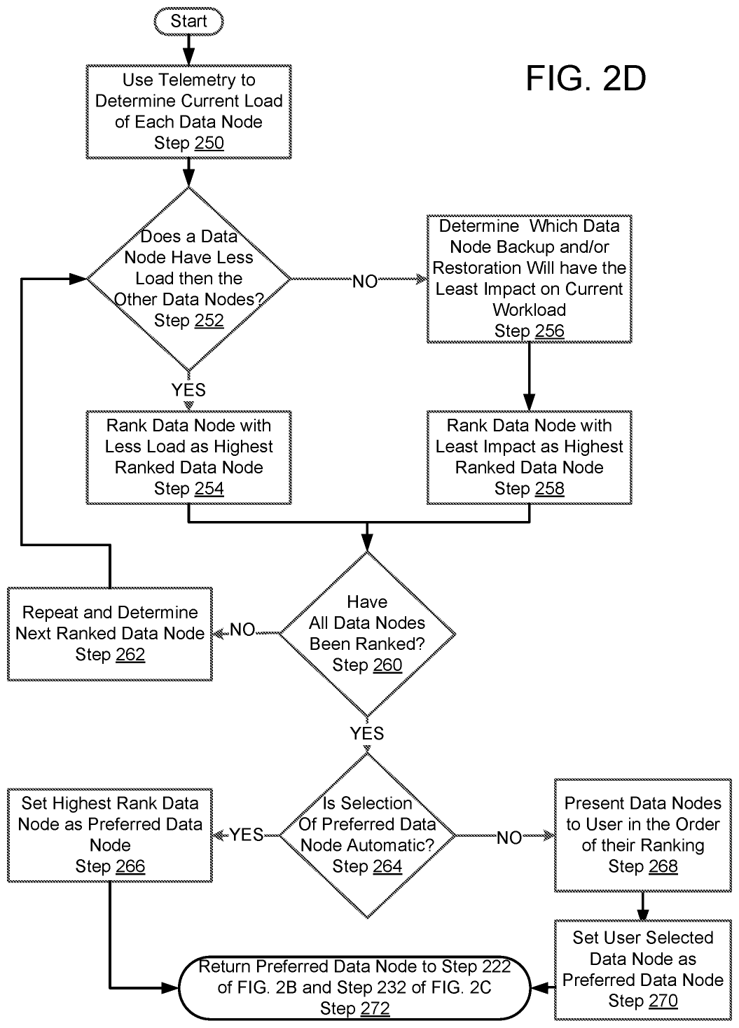

In one or more embodiments of the invention, the data protection manager (104) initiates data protection events such as discovery, backup, and restoration. The data protection manager (104) communicates with the cluster (100) so that the cluster manager (110) or appropriate node (e.g., 102A-102C) may carry out the data protection event. The data protection manager (104) in one or more embodiments of the invention receives requests for performing data protection events including backups and restorations of selected assets. The data protection manager (104) coordinates and communicates with one or more data nodes (e.g., 102A-102C) to select a preferred data node and have the preferred data node perform the data protection event, as is described in more detail below with regards to the methods shown in FIGS. 2A-2D.

In one or more embodiments of the invention, the data protection manager (104) may include a user interface that allows a user or administrator to configure or change a data protection event. This may include displaying a graphical user interface (GUI) that presents options, including rankings of the available data nodes (e.g., 102A-102C) to a user or administrator that they may select from, such as a preferred data node to perform the data protection event, or indications of which assets/applications a user or administrator wants to have protected.

In one or more embodiments of the invention, the data protection manager (104) may determine a preferred data node (e.g., 102A-102C) for performing data protection such as a restoration on a given asset such as a specific application and its data and/or an entire volume. An example of the method for determining the preferred data node is shown in FIG. 2D. The determination of the preferred data node may be done during periodic discovery, after receiving a request for a data protection event (such as those discussed in more detail below with regards to the methods shown in FIGS. 2A-2C), or at any other configured time as configured by a user, administrator, or system designer/manufacturer.

In one or more embodiments of the invention, when a data protection event is initialized, such as a restoration, the data protection manager (104) may request and receive telemetry from each of the data nodes (e.g., 102A-102C). Upon reception of the telemetry the data protection manager (104) may determine the preferred data node based on runtime operational data of each of the active data nodes (e.g., 102A-102C) as well as analyzing any previous backups that have been performed on a selected asset.

Prior to performing a restoration, the data protection manager (104) may analyze the backup(s) the restoration will be performed from. The backups are analyzed to determine information which allows the data protection manager (104) to determine which data node (e.g., 102A-102C) is the preferred data node for performing the event. In at least the case where the event is a restoration, this may include determining which data node (e.g., 102A-102C) originally performed the backup. The data protection manager (104) may also analyze the type of backup that was performed, such as, but not limited to, a full, incremental, block-based backup (BBB), or file-based backup (FBB). Each backup type has different requirements and requires different amounts of resources when the backup is restored.

Based on the telemetry, analyzation of the original backups, and other pertinent information such as user/administrator input; the data protection manager (104) may determine a preferred data node. Once the preferred data node is determined, the data manager (104) may signal the preferred data node to perform the data protection event such as perform a backup or restoration. The method, of determining the preferred data node and performing a backup and/or a restoration with the preferred data node, in accordance with one or more embodiments of the invention, is described in more detail below with regards to the methods shown in FIGS. 2A-2D.

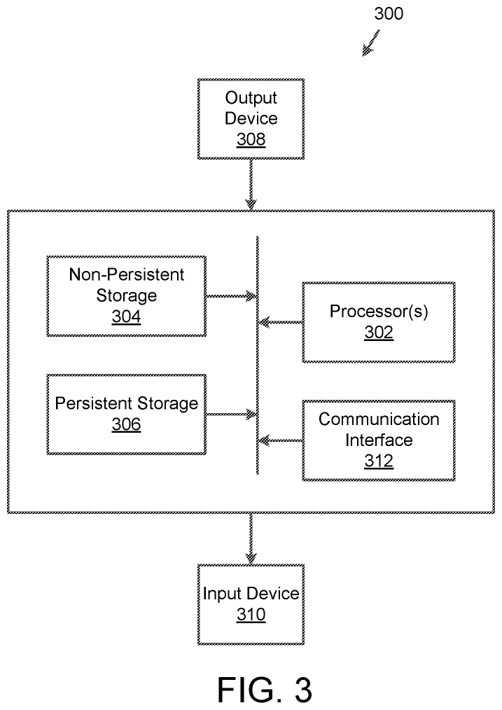

In one or more embodiments of the invention, the data protection manager (104) is implemented as a computing device (see e.g., FIG. 3). The computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data protection manager (104) described throughout this application.

In one or more embodiments of the invention, the data protection manager (104) is implemented as a logical device. The logical device may utilize the computing resources of any number of computing devices and thereby provide the functionality of the data protection manager (104) described throughout this application.

In one or more embodiments of the invention, the data protection manager (104) works with backup storage (106) to store backups and mapping information. Backup storage may comprise of local storage/volumes that are stored in any of the local storage devices (e.g., 114A-114C) or the cluster shared volumes (120). In one or more embodiments of the invention, the backup storage (106) may comprise of storage that is not part of the cluster (100). Backup storage (106) may also comprise of off-site storage including but not limited to, cloud base storage, and long-term storage such as tape drives, depending on the particular needs of the user and/or the system. The backup storage (106) may include one or more processors, memory (e.g., random access memory), and persistent storage (e.g., disk drives, solid state drives, etc.).

In one or more embodiments of the invention, the backup storage (106) includes the functionality to provide backup storage services to the data nodes (e.g., 102A-102C) as discussed above. The backup storage services may include (i) obtaining backups of data generated through the performance of computer implemented services from the data nodes (e.g., 102A-102C), (ii) storing data and metadata associated with the backups in persistent storage of the backup storage (106), and (iii) providing backups to the data nodes (e.g., 102A-102C) for restoration purposes and/or other purposes without departing from the invention. The backup storage services may include the functionality to provide and/or obtain additional services without departing from the invention. The backup storage (106) may include any number of backup storages without departing from the invention.

In one or more embodiments of the invention, the backup storage (106) is implemented as a computing device (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device cause the computing device to perform the functionality of a backup storage (106) described throughout this application.

In one or more embodiments of the invention, the backup storage (106) is implemented as a logical device. The logical device may utilize the computing resources of any number of computing devices and thereby provide the functionality of the backup storage (106) described throughout this application.

In one or more embodiments of the invention, the data protection manager (104) and backup storage (106), communicate with the cluster (100) through a network (108). The network (108) may take any form of network including any combination of wireless and/or wired networks. The network (108) may be a local network (LAN) or a wide area network (WLAN) including the Internet or a private enterprise network that connects more than one location. The network (108) may be any combination of the above networks, other known network, or any combination of network types.

In one or more embodiments of the invention, the network (108) allows the cluster (100) to communicate with other clusters (not shown) and external computing devices such as (but not limited to) a data protection manager (e.g., 104) and backup storage (e.g., 106). The various components of the cluster (100) may also communicate with each other through a network. The network may be a high-speed internal network and/or include part of an external network (108). The data nodes (e.g., 102A-102C), cluster share volume (e.g., 120) and cluster manager (e.g., 110) communicate with each other over the internal network and in one or more embodiments of the invention provide fallback functionality.

A network (e.g., network (108)) may refer to an entire network or any portion thereof (e.g., a logical portion of the devices within a topology of devices). A network may include a data center network, a wide area network, a local area network, a wireless network, a cellular phone network, and/or any other suitable network that facilitates the exchange of information from one part of the network to another. A network may be located at a single physical location or be distributed at any number of physical sites. In one or more embodiments, a network may be coupled with or overlap, at least in part, with the Internet.

In one or more embodiments, although shown separately in FIG. 1, the network (108) may include any number of devices within any components (e.g., 100, 104, and 106) of the system, as well as devices external to, or between, such components of the system. In one or more embodiments, at least a portion of such devices are network devices (not shown). In one or more embodiments, a network device is a device that includes and/or is operatively connected to persistent storage (not shown), memory (e.g., random access memory (RAM)) (not shown), one or more processor(s) (e.g., integrated circuits) (not shown), and at least two physical network interfaces, which may provide connections (i.e., links) to other devices (e.g., computing devices, other network devices, etc.). In one or more embodiments, a network device also includes any number of additional components (not shown), such as, for example, network chips, field programmable gate arrays (FPGAs), application specific integrated circuits (ASICs), indicator lights (not shown), fans (not shown), etc. A network device may include any other components without departing from the invention. Examples of a network device include, but are not limited to, a network switch, a router, a multilayer switch, a fibre channel device, an InfiniBand® device, etc. A network device is not limited to the aforementioned specific examples.

In one or more embodiments, network devices are configured to participate in one or more network protocols, which may include discovery schemes and data protection events such as the methods described in FIGS. 2A-2D. Discovery schemes are a way to discover, prior to performing a data protection event, information about all or any of the network topology in which the network device exists. Such discovery schemes may include sharing of information between network devices and may also include providing information to other devices within the system, such as, for example, data nodes (e.g., 102A-102C), backup storage (e.g., 120) and/or shared storages (e.g., 110).

In one or more embodiments of the invention, a data cluster (e.g., 100) may be implemented as one or more computing devices. A data cluster (e.g., (100)) may include any number of computing devices without departing from the invention. The data cluster may include different computing devices, different quantity, and types of computer resources, and may perform different computer implemented services without departing from the invention.

In one or more embodiments of the invention, the data cluster (100) includes a plurality of data nodes (e.g., 102A-102C) which include the functionality to obtain data protection services from the data protection manager (e.g., 104) and/or the cluster manager (e.g., 110). While shown as including only three data nodes (e.g., 102A-102C), the data cluster (100) may include more or less data nodes without departing from the invention, for example a cluster (e.g., 100) could comprise of at least sixteen data nodes, at least fifty data nodes, or at least a hundred data nodes without departing from the invention. The cluster may also include shared storage including at least one cluster shared volume (CSV) (e.g., 120) which is active with each of the data nodes (e.g., 102A-102C) of the data cluster (100). Other types of shared storage may also or alternatively be included such as active-passive storage and local storage (e.g., 114A-114C).

In one or more embodiments of the invention, the data nodes (e.g., 102A-102B) perform workloads and provide services to clients and/or other entities not shown in the system illustrated in FIG. 1. The data nodes (e.g., 102A-102C)) may further include the functionality to perform computer implemented services for users (e.g., clients, not shown) of the data cluster (100). The computer implemented services may include, for example, database services, electronic mail services, data processing services, etc. The computer implemented services may include other and/or additional types of services without departing from the invention.

During the performance of the aforementioned services, data may be generated and/or otherwise obtained. The data nodes (e.g., 102A-102C) include local storage (e.g., 114A-114C) which may include multiple volumes, as well as shared storage which may include cluster shared volumes (CSVs e.g., 120). The various data storage volumes (e.g., 114A-114C as well as CSV (120)) performing data storage services may include storing, modifying, obtaining, and/or deleting data stored on the shared storages (e.g., 120). The data storage services may include other and/or additional services without departing from the invention. The data generated and stored on the shared storages (e.g., 114A-114C as well as CSV (120)) by the data nodes (e.g., 102A-102C) may be valuable to users of the system, and therefore may be protected. The data nodes (e.g., 102A-102C) may obtain backup storage services from the backup storage (106). Alternatively, the data nodes (e.g., 102A-102C) may provide backup storage services themselves and include backup storage on the local storage (e.g., 114A-114C) or the cluster shared volumes (e.g., 120). The backup storage services may include storing backups of data stored on the shared storages for restoration purposes. The backup storage services may include other and/or additional services without departing from the invention.

The data nodes (e.g., 102A-102C) may include the functionality to perform data protection services for data stored in the various data storage volumes (e.g., 114A-114C as well as CSV 120). The data protection services may include generating backups of data stored in the shared storages (110) and storing the backups in the backup storage (110). The data nodes (e.g., 102A-102C) may include the functionality to perform other and/or additional services without departing from the invention.

The data nodes (e.g., 102A-102C) may include a primary data node (e.g., 102A) and secondary data nodes (e.g., 102B and 102C). The specific configuration of which data node is the primary data node and which data node is the secondary data node may be preconfigured or may be automatically managed by the cluster manager (e.g., 110). The data nodes (e.g., 102A-102C) may include any number of secondary data nodes without departing from the invention. Alternatively, all data nodes (e.g., 102A-102C) may be secondary data nodes with the cluster manager (e.g., 110) performing the additional tasks of the primary node.

The data nodes (e.g., 102A-102C), may be operably connected to one or more cluster shared storages (e.g., 120) and may obtain data storage services from the one or more cluster shared storages (e.g., 120). The data nodes (e.g., 102A-102C) may be operably connected to each other, and each data node (e.g., 102A) may include the ability to use all or part of the volumes, including shared active-passive drives that form the local storage (e.g., 114A-114C) of the other data nodes (e.g., 102B and 102C).

In one or more embodiments of the invention, the data nodes (e.g., 102A-102C) are implemented as computing devices (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the data nodes (e.g., 102A-102C) described throughout this application.

In one or more embodiments of the invention, the data nodes (e.g., 102A-102C) are implemented as a logical device. The logical device may utilize the computing resources of any number of computing devices and thereby provide the functionality of the data nodes (e.g., 102A-102C) described throughout this application.

In one or more embodiments of the invention, the data nodes (e.g., 102A-102C) include storage that includes local storage (e.g., 114A-114C) that is associated with only their assigned data node. The storage also includes shared storage such as a cluster shared volume CSV (e.g., 120). The storage may also include other types of shared volumes including active-passive shared volumes which only provide data storage services to the data nodes they are active on.

The data nodes (e.g., 102A-102C) as well as other components of the cluster and connected devices may perform data storage services. The data storage services may include storing, modifying, obtaining, and/or deleting data stored on the local and shared storages (e.g., 114A-114C and 120) based on instructions and/or data obtained from the data nodes (e.g., 102A-102C) or other components of the cluster (e.g., 100). The data storage services may include other and/or additional services without departing from the invention. The local and shared storages (e.g., 114A-114C and 120) may include any number of storage volumes without departing from the invention.

The local and shared storages (e.g., 114A-114C and 120) may include storage devices (not shown) for storing data. The storage devices may be physical storage devices and/or logical storage devices. The physical storage devices may include any combination of hard disk drives, solid state disk drives, tape drives, and/or any other physical storage mediums for the storage of data.

The logical storage devices (e.g., virtualized storage) may utilize any quantity of hardware storage resources of any number of computing devices for storing data. For example, the local and shared storages (e.g., 114A-114C and 120) may utilize portions of any combination of hard disk drives, solid state disk drives, tape drives, and/or any other physical storage medium of any number of computing devices.

In one or more embodiments of the invention, the local and shared storages (e.g., 114A-114C and 120) are implemented as computing devices (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the local and shared storages (e.g., 114A-114C and 120) described throughout this application.

In one or more embodiments of the invention, the data nodes (e.g., 102A-102C) as well as the associated local and shared storages (e.g., 114A-114C and 120) are managed by a cluster manager (e.g., 110). The cluster manager (110) performs a plurality of functions not limited to managing and configuring the services provided by the data nodes (e.g., 102A-102C), managing the mapping and movement of data on the at least she shared volumes including any cluster shared volumes (e.g., 120). The cluster manager (110) may perform other functions attributed to other components of the system or function not described herein without departing from the invention.

In one or more embodiments of the invention the cluster manager (110) includes the functionality to perform a portion, or all of, the data protection services of the data protection manager (104). This may include performing discovery of the volumes and assets associated with the data nodes (e.g., 102A-102C) including those stored on the local storage (e.g., 114A-114C) and the CSV (e.g., 120). This may also include performing, or initiate backups and restorations as well as determining a preferred data node including some or all of the functions described above as being ascribed to a data protection manager (e.g., 104) as well as the functions and method described in the method shown in FIGS. 2A-2D and described below. The cluster manager (110) may include the functionality to perform and or obtain other and/or additional services without departing from the invention.

In one or more embodiments of the invention, the cluster manager (110) may perform discovery on the volumes and assets of the volumes and assets associated with the data nodes (e.g., 102A-102C) including those stored on the local storage (e.g., 114A-114C) and the CSV (e.g., 120). The cluster manager queries each data node (e.g., 102A-102C) and their associated local and shared storage (e.g., 114A-114C and 120). Using the results of the query, the cluster manager (110) produces an asset mapping, which is stored on each of the data nodes (e.g., 102A-102C). This allows for each of the data nodes (e.g., 102A-102C) to know where a given asset is located at any given time. By updating the discovery periodically, such as, but not limited by, every fifteen seconds, the asset mapping (e.g., 128) may remain accurate and provide quicker access times with less or no inter-node messaging. Further if one data node fails, the location of at least the shared assets is not lost.

In one or more embodiments of the invention, the cluster manager (110) may in addition to, or instead of the data protection manager (e.g., 104), determine the preferred data node for performing of data protection such as a backup on a given asset such as a specific application and its data and/or an entire volume. An example of the method for determining the preferred data node is shown in FIG. 2D. This may be done during the periodic discovery described above, or as a result of a data protection event as shown in FIGS. 2A-2C, or at any other configured time as configured by a user, administrator, or system designer/manufacturer.

In one or more embodiments of the invention, the cluster manager (e.g., 110, FIG. 1) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the cluster manager (e.g., 110, FIG. 1) described throughout this application.

In one or more embodiments of the invention, the cluster manager (e.g., 110, FIG. 1) is implemented as computer instructions, e.g., computer code, stored on a persistent storage that when executed by a processor of the cluster (e.g., 100, FIG. 1) including any-one-of the data nodes (e.g., 102A-102C, FIG. 1) to provide the functionality of the cluster manager (e.g., 110, FIG. 1) described throughout this application.

In one or more embodiments of the invention, the cluster manager (e.g., 110, FIG. 1) is implemented as a computing device (see e.g., FIG. 3). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device cause the computing device to perform the functionality of a cluster manager (e.g., 110, FIG. 1) described throughout this application.

In one or more embodiments of the invention, the cluster manager (e.g., 110, FIG. 1) is implemented as a logical device. The logical device may utilize the computing resources of any number of computing devices and thereby provide the functionality of the backup storage (e.g., 106, FIG. 1) described throughout this application.

In one or more other embodiments of the invention, one or more of the functions of the cluster manager (e.g., 110, FIG. 1) may be performed by a data protection manager (e.g., 104, FIG. 1), a backup storage (e.g., 106, FIG. 1), the individual data nodes (e.g., 102A-102C, FIG. 1), or other component of the system without departing from the invention.

FIG. 2A shows a flowchart of a method for performing a protection event. The method may be performed by, for example, a data protection manager (e.g., 104, FIG. 1) a cluster manager (e.g., 110, FIG. 1), and/or a data node (e.g., 102A-102C, FIG. 1). Other components of the system illustrated in FIG. 1 may perform all, or a portion, of the method of FIG. 2A without departing from the invention.

While FIG. 2A is illustrated as a series of steps, any of the steps may be omitted, performed in a different order, include additional steps, and/or perform any or all of the steps in a parallel and/or partially overlapping manner without departing from the invention.

In step 200, a data protection event is initialized. In one or more embodiments of the invention this may be initialized based on an automatic policy or by a user/administrator's request. In accordance with one or more other embodiments of the invention the data protection event may be initialized automatically when one or more data nodes have a failover event. Other means for initializing a protection event discovery event associated with a data cluster may be used without departing from the invention.

During the initialization of the data protection event, a user, administrator, or a component of the system such as the data protection manager (e.g., 104, FIG. 1) determines which assets are to be protected by the data protection event. The selected assets may be one or more selected applications (including the file system itself) that are associated with one or more data nodes (e.g., 102A-102C, FIG. 1). The selected assets in accordance with one or more embodiments of the invention may be selected files and/or folders of an individual volume. Alternatively, the selected assets may be one or more volumes (e.g., 114A-114C and 120, FIG. 1) associated with the data nodes (e.g., 102A-102C, FIG. 1) or any combination of applications, files, folders, and volumes. Other aspects of the system may be selected for backup without departing from the invention.

If not previously performed or needing updating, once the data protection event is initialized, discovery is performed in step 202. In accordance with one or more embodiments of the invention, discovery (e.g., step 202) is performed at least prior to the performance of one or more data protection events. Discovery, in accordance with one or more embodiments of the invention, may also or alternatively be performed periodically such as every five minutes or other predetermined period of time, and may be performed prior or outside of the method of FIG. 2A. Its location after step 200 is only exemplary, and in accordance with one or more embodiments of the invention, discovery may be performed at any time, that the data protection policies and/or user/administrator preferences configured the discovery to take place.

Discovery may map all of the assets of a cluster (e.g., 100, FIG. 1) or subset of the assets including at least the selected assets. The mapping may be stored in each of the data nodes (e.g., 102A-102C, FIG. 1), the CSV (e.g., 120, FIG. 1), cluster manager (e.g., 110, FIG. 1), the data protection manager (e.g., 104, FIG. 1), backup storage (e.g., 106, FIG. 1) or other predetermined component/storage of the cluster (e.g., 100, FIG. 1) and related system.

In accordance with one or more embodiments of the invention, during discovery (e.g., step 202 of FIG. 2A), a preferred data node may be selected for performance of a data protection event. An exemplary method for deterring the preferred data node is shown in FIG. 2D as described below. Other methods of determining a preferred data node may be used without departing from the invention. Further the preferred data node may be determined prior to or during other steps of the method of FIG. 2A, including, in one or more embodiments, in steps 206 and 210.

Turning back to the method of FIG. 2A, once the data protection event is initialized in step 200 and in accordance with one or more embodiments of the invention, discovery is performed in step 202, the method proceeds to step 204. In step 204 a determination is made if the protection event is a backup and/or a restoration of the selected assets. If the event includes a backup the method proceeds to step 206, alternatively if the event only includes a restoration of selected assets, the method proceeds to step 210.

While step 204 only describes determining between backup and restoration events, other data protection events following similar steps to either the backup or restoration steps as appropriate, may be performed without departing form the invention. Such other events may include snapshots, archiving, migrating, and other data protection events.

In step 206, in accordance with one or more embodiments of the invention, a backup is performed by a data node, such as a preferred data node that is determined according to the method described below with regards to FIG. 2D. The backup may also use the asset mapping produced during discovery (e.g., step 202). Alternatively, the mapping used for performing the backup in step 206 may be produced by other means.

In one or more embodiments of the invention, the method for performing the backup on the selected assets is described in more detail with regards to the method shown in FIG. 2B. Once the backup is performed in step 206, the method proceeds to step 208.

In step 208, in accordance with one or more embodiments of the invention, it may be determined if the protection policy event also includes performing a restoration. If a restoration is also to be performed, the method proceeds to step 210. If a restoration is not to be performed, in one or more embodiments of the invention, the method ends following step 208.

If the data protection event is determined, in step 204 or 208, to also, or alternatively, include performing a restoration, the method proceeds to step 210. In step 210 a restoration is performed using a preferred data node. As in step 206, the preferred data node may be determined by performing the method of shown in FIG. 2D. Other method of determining a preferred data node may be used without departing from the invention.

The method for performing the restoration is described in more detail below with regards to the method shown in FIG. 2C. Other methods of performing the restoration may be used besides that discussed below with regards to FIG. 2C. Once the restoration is completed the method ends following step 210 (or step 208 as discussed in the previous paragraph).

FIG. 2B shows a flowchart of a method for performing a backup using a preferred data node. The method may be performed after a data protection event is initiated as described above with regards to the method of FIG. 2A, or the method may be performed at any time that a backup of a selected asset using a preferred data node, is needed. The method may be performed by, for example, a data protection manager (e.g., 104, FIG. 1) or a cluster manager (e.g., 110, FIG. 1). Other components of the system illustrated in FIG. 1 may perform all, or a portion, of the method of FIG. 2B without departing from the invention.

While FIG. 2B is illustrated as a series of steps, any of the steps may be omitted, performed in a different order, include additional steps, and/or perform any or all of the steps in a parallel and/or partially overlapping manner without departing from the invention.

In step 220, in accordance with one or more embodiments of the invention, a backup of a selected asset is initiated. The backup may be for a specific asset that has been chosen by a user, administrator, data protection manager (e.g., 104, FIG. 1), data node (e.g., 102A-102C, FIG. 1) or other component of the system of FIG. 1. The asset may take the form of one or more applications and their related data, a file, a folder, or may comprise of restoring entire volumes, hosts, or other assets of the system. If the selected asset or backup is not associated with shared storage such as the CSV (e.g., 120, FIG. 1), then in one or more embodiments of the invention the preferred data node may be the data node that initiated the backup or is associated with the asset. However, if the asset is associated with shared storage such as the CSV (e.g., 120, FIG. 1) or in general associated with more than one data node (e.g., 102A-102C, FIG. 1), the method proceeds to step 222.

In step 222, a preferred data node is determined. While shown being performed between steps 220 and 224 of the method of FIG. 2B, step 222 may be performed at any time prior to the performance of step 224, including during the discovery step 202 of the method of FIG. 2A described above. In one or more embodiments of the invention, the preferred data node is determined as described below with regards to the method shown in FIG. 2D. Other methods for determining the preferred data node may be used without departing from the invention.

Once the preferred data node is determined in step 222, the method of FIG. 2B proceeds to step 224, where the preferred data node determined in step 222, performs the backup.

In one or more embodiments of the invention, the method ends following step 224.

FIG. 2C shows a flowchart of a method for performing a restoration using a preferred data node. The method may be performed during after a data protection event is initiated as described above with regards to the method of FIG. 2A, or the method may be performed at any time that a restoration of an asset using a preferred data node is needed. The method may be performed by, for example, a data protection manager (e.g., 104, FIG. 1) or a cluster manager (e.g., 110, FIG. 1). Other components of the system illustrated in FIG. 1 may perform all, or a portion, of the method of FIG. 2C without departing from the invention.

While FIG. 2C is illustrated as a series of steps, any of the steps may be omitted, performed in a different order, include additional steps, and/or perform any or all of the steps in a parallel and/or partially overlapping manner without departing from the invention.

In step 230, in accordance with one or more embodiments of the invention, a restoration is initiated. The restoration may be from or for a specific backup that was backed up in accordance to at least step 206 of the method of FIG. 2A. Alternatively, the restoration may be for a specific asset that has been chosen by a user, administrator, data protection manager (e.g., 104, FIG. 1), data node (e.g., 102A-102C, FIG. 1) or other component of the system of FIG. 1. The asset may take the form of one or more applications and their related data, a file, a folder, or may comprise of restoring entire volumes, hosts, or other assets of the system that have been previously backed up. If the selected asset and its associated backup is not associated with shared storage such as the CSV (e.g., 120, FIG. 1), then just the telemetry from the data node associated with the asset to be restored is obtained and that data node performs the restoration.

If, however, the selected asset and/or its associated backup is associated with shared storage such as the CSV (e.g., 120, FIG. 1), once the restoration is initiated in step 230, the method proceeds to step 232 where in accordance with one or more embodiments of the invention, a preferred data node (e.g., 102A-102C, FIG. 1) is determined for performing the restoration in step 234. In accordance with one or more embodiments of the invention the preferred data node is determined based on the method discussed below with regards to the method shown in FIG. 2D. Other methods for obtaining the preferred data node may be used without departing from the invention.

After the preferred data node (e.g., 102A, FIG. 1) is determined in step 234, the method proceeds to step 234. In step 234 a determination is made, using telemetry or other real-time information, whether the preferred data node (e.g., 102A, FIG. 1) determined in step 232 is currently performing a backup. If the determination in step 234 is that the preferred data node (e.g., 102A, FIG. 1) is not performing a backup the method proceeds to step 236, where the preferred data node (e.g., 102A, FIG. 1) performs the restoration on the selected data node and the method ends.

Alternatively, if in step 234, it is determined that the preferred data node (e.g., 102A, FIG. 1) is currently performing a backup, in accordance with one or more embodiments of the invention, the method proceeds to step 238. In step 238 the next best data node (e.g., 102C, FIG. 1) not performing a backup (as determined in step 232 and described in more detail with regards to FIG. 2D), is selected to perform the restoration. Once the next best data node (e.g., 102C, FIG. 1) is selected, the method of FIG. 2C again returns to step 236 and the selected asset is restored on the next best data node (e.g., 102C, FIG. 1). The next best node may be the second highest ranked node for a given restoration, where the ranking is described in FIG. 2D.

In one or more embodiments of the invention, the method ends following step 236.

FIG. 2D shows a flowchart of a method for determining a preferred data node for performing a restoration of selected assets in accordance with one or more embodiments of the invention. In one or more embodiments of the invention the method may also be used for determining a preferred data node to perform a backup of a selected asset. The method may be performed in accordance with one or more embodiments of the invention by a data protection manager (e.g., 104, FIG. 1). Other components of the system such as the cluster manager (e.g., 110, FIG. 1) may perform all, or a portion, of the method of FIG. 2D without departing from the invention.

While FIG. 2D is illustrated as a series of steps, any of the steps may be omitted, performed in a different order, include additional steps, and/or perform any or all of the steps in a parallel and/or partially overlapping manner without departing from the invention.

In step 250, in accordance with one or more embodiments of the invention, the method of FIG. 2D begins by obtaining telemetry for each data node (e.g., 102A-102C, FIG. 1). The telemetry may include such things as the current load of the data node (e.g., 102A-102C, FIG. 1), how may hosts or application are active on the data node (e.g., 102A-102C, FIG. 1), what the current workload is for the data node (e.g., 102A-102C, FIG. 1), and any other pertinent data. In one or more embodiments of the invention, the telemetry is obtained in real-time when a data protection event (such as those described above with regards to FIGS. 2B and 2C) is initialized. Alternatively, in accordance with one or more embodiments of the invention, the telemetry is obtained periodically, including but not limited to, when discovery (e.g., step 202, FIG. 2A) is performed. Once the telemetry is obtained, the method proceeds to step 252.

In step 252, the method determined, based on the telemetry obtained in step 250, if a data node (e.g., 102A, FIG. 1) has less load then the other data nodes (e.g., 102B and 102C, FIG. 1). If the data node has load then the other data nodes, the method proceeds to step 254 and the data node (e.g., 102A, FIG. 1) with less load is ranked higher (or highest) then those with more load ((e.g., 102B and 102C, FIG. 1). If instead the data node does not have less load (for example when all of the data nodes have the same load or are approximately balanced, for example within 5% of each other), the method, in accordance with one or more embodiments of the invention proceeds to step 256.

In step 256, based on the workload of each data node (e.g., 102A-102C, FIG. 1) as well as the type of backup associated with the backup or restoration, and/or other concerns; the data node that the backup and/or restoration will have the least impact on its current workload is determined. For example, if data node 102B of FIG. 1, while having the same load as 102A of FIG. 1, never-the-less is more efficient at performing full block-based backups then node 102A, then data node 102B may be determined to be able to perform the backup in step 256 with the least impact on its current load. Similarly, as an example, if data node 102C of FIG. 1 has the same load as data node 102B of FIG. 1, but 102C's current workload is such that a restoration will have less impact on the workload then that of 102B, then 102C may be determined to be able to perform the restoration in step 256 with the least impact on its current load. Both of these examples are exemplary and are not limiting on the invention. Other combinations of data nodes including more than three data nodes (for example more than one hundred data nodes) with different loads, workloads, and capabilities may be considered in step 256 without departing from the invention.

Once step 256 determines which data node (e.g., 102A-102C, FIG. 1), the data protection event (i.e., backup or restoration) will have the least impact on, in accordance with one or more embodiments of the invention, the method proceeds to step 258. In step 258 the data node that the data protection event will have the least impact on is ranked higher (or highest) then the other data nodes.

In accordance with one or more embodiments of the invention, once a rank is given to a data node in either step 254 or 258, the method proceeds to step 260. In step 260 it is determined if all the data nodes (e.g., 102A-102C, FIG. 1) have been ranked. If they have not, the method proceeds to step 262, which causes steps 252-258 to repeat until all available data nodes (e.g., 102A-102C, FIG. 1) are ranked.

Once all the data nodes (e.g., 102A-102C, FIG. 1) are ranked, the method in accordance with one or more embodiments of the invention, proceeds to step 264. Alternatively, if it is not necessary to determine the rank of more than one data node, steps 260 and 262 may be skipped and the method will proceed directly from steps 254 and 258 to step 264.

In step 264, in accordance with one or more embodiment of the invention, a determination is made for example by the data protection manager (e.g., 104, FIG. 1) or other component of the system that is managing the data protection event, if the preferred data node is to be determined automatically. If the preferred data node is to be determined automatically by the data protection manager (e.g., 104, FIG. 1) or other component of the system, the method proceeds to step 266 where the highest rank data node is set as the preferred data node.

Otherwise, in accordance with one or more embodiments of the invention, the method proceeds to step 268 where a user or administrator is presented a list of the data nodes ranked as determined in steps 252-260. Using this list, the user or administrator is able to choose a preferred data node based on that user or administrator's preferences as well as the assigned rank of the data node (e.g., 102A-102C, FIG. 1). The lists in one or more embodiments of the invention may be presented on a display which is displaying a graphical user interface (GUI). The user then may determine based on a variety of factors which data node they would prefer to have the data protection event (e.g., backup or restoration) performed on. Other means for displaying and choosing the preferred data node by a user or administrator may be used without departing from the invention. Once the user or administrator selects a data node (e.g., 102A-102C, FIG. 1), the method proceeds to step 270, where the selected data node is set as the preferred data node (e.g., 102A, FIG. 1).

In one or more embodiments of the invention, the method ends following step 272 and the determined preferred data node is returned to step 222 of FIG. 2B, step 232 of FIG. 2C or any other step of any method for performing a data protection event with a preferred data node.

As discussed above, embodiments of the invention may be implemented using computing devices. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth® interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many diverse types of computing devices exist, and the aforementioned input and output device(s) may take other forms.

One or more embodiments of the invention may be implemented using instructions executed by one or more processors of the cluster manager. Further, such instructions may correspond to computer readable instructions that are stored on one or more non-transitory computer readable mediums.

One or more embodiments of the invention may improve the operation of one or more computing devices in a cluster environment. Specifically, embodiments of the invention relate to a method of performing a backup and/or restoration of at least one selected asset located in the data cluster.

When a backup is triggered, an initial data node that the backup is triggered on or directed to performs the backup and/or it coordinates it with another node. When a restoration is triggered, the original data node that performs the backup of the at least one selected asset, performs the restoration. However, in a duster environment in both cases, the data node that performs the data protection event (the backup and/or restoration) may not be the best or appropriate node to use. This may result in collisions and other problems that lead to a failure of the protection event. Further in the traditional method of performing a protection event in a cluster environment, there is no straightforward way for a user or administrator to specify which data node should perform the protection event.

One or more embodiments of the invention improves upon the traditional method of performing a backup and/or restore, by either allowing a user or administrator to choose a preferred data node for performing the data protection event, or by having a data protection manager or similar component of a system dynamically choses a preferred data node for performing the data protection event based on predetermined criteria. Such predetermined criteria may include each data node's load and workload as well as the type of backup that will be or was performed. This will allow for a more efficient backup and/or restoration, while avoiding overloading and collisions.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments may be devised which do not depart from the scope of the technology as disclosed herein. Accordingly, the scope of the invention should be limited only by the attached claims.

What is claimed is:

1. A method for performing at least one of a backup and restoration of at least one asset in a cluster environment comprising of a plurality of data nodes, the method comprising:
receiving, by a data protection manager, a request to back up the at least one asset;
initiating, by the data protection manager, a backup of the at least one asset;
receiving, by the data protection manager, telemetry from the plurality of data nodes;
using, by the data protection manager, at least the telemetry to determine a preferred data node; and
signaling, by the data protection manager, the preferred data node to perform the backup of the at least one asset.

2. The method of claim 1, further comprising:
receiving, by the data protection manager, a request to restore the at least one asset from the backup of the at least one asset;
receiving, by the data protection manager, updated telemetry from the plurality of data nodes;
using, by the data protection manager, at least the updated telemetry to determine a preferred restore data node from the plurality of data nodes; and
signaling, by the data protection manager, the preferred restore data node to perform the restoration of the at least one asset,
wherein the preferred restore data node is different than the preferred data node,
wherein the preferred restore data node is selected based on the updated telemetry indicating that it is not currently performing any backups.

3. The method of claim 2, wherein a user of the cluster environment selects the preferred restore data node.

4. The method of claim 2, wherein the updated telemetry includes the current load of each of the plurality of data nodes.

5. The method of claim 1, wherein a user of the cluster environment selects the preferred data node.

6. The method of claim 1, wherein the telemetry includes a current load of each of the plurality of data nodes.

7. The method of claim 6, wherein the preferred data node is determined, at least in part, based on which of the plurality of data nodes the telemetry shows has the lowest current load.

8. The method of claim 7, wherein the preferred restore data node is determined, at least in part, based on which of the plurality of data nodes the updated telemetry shows has the lowest current load.

9. A non-transitory computer readable medium comprising computer readable program code, which when executed by a computer processor enables the computer processor to perform a method for performing at least one of a backup and restoration of at least one asset in a cluster environment comprising of a plurality of data nodes, the method comprising:
receiving, by a data protection manager, a request to back up the at least one asset;
initiating, by the data protection manager, a backup of the at least one asset;
receiving, by the data protection manager, telemetry from the plurality of data nodes;
using, by the data protection manager, at least the telemetry to determine a preferred data node; and
signaling, by the data protection manager, the preferred data node to perform the backup of the at least one asset.

10. The non-transitory computer readable medium of claim 9, wherein the method further comprises:
receiving, by the data protection manager, a request to restore the at least one asset from the backup of the at least one asset;
receiving, by the data protection manager, updated telemetry from the plurality of data nodes;
using, by the data protection manager, at least the updated telemetry to determine a preferred restore data node from the plurality of data nodes; and
signaling, by the data protection manager, the preferred restore data node to perform the restoration of the at least one asset,
wherein the preferred restore data node is different than the preferred data node,
wherein the preferred restore data node is selected based on the updated telemetry indicating that it is not currently performing any backups.

11. The non-transitory computer readable medium of claim 10, wherein a user of the cluster environment selects the preferred restore data node.

12. The non-transitory computer readable medium of claim 10, wherein the updated telemetry includes the current load of each of the plurality of data nodes.

13. The non-transitory computer readable medium of claim 9, wherein a user of the cluster environment selects the preferred data node.

14. The non-transitory computer readable medium of claim 9, wherein the telemetry includes a current load of each of the plurality of data nodes.

15. The non-transitory computer readable medium of claim 14, wherein the preferred data node is determined, at least in part, based on which of the plurality of data nodes the telemetry shows has the lowest current load.

16. The non-transitory computer readable medium of claim 15, wherein the preferred restore data node is determined, at least in part, based on which of the plurality of data nodes the updated telemetry shows has the lowest current load.

17. A system comprising:
a plurality of data nodes; and
a data protection manager which comprises of:
at least one processor;
at least one storage device; and
at least one memory that includes instructions, which when executed by the processor, performs a method for performing at least one of a backup and restoration of at least one asset in a cluster environment comprising of the plurality of data nodes, the method comprising:
receiving, by the data protection manager, a request to back up the at least one asset;
initiating, by the data protection manager, a backup of the at least one asset;
receiving, by the data protection manager, telemetry from the plurality of data nodes;
using, by the data protection manager, at least the telemetry to determine a preferred data node; and
signaling, by the data protection manager, the preferred data node to perform the backup of the at least one asset.

18. The system of claim 17, wherein the method further comprises:
receiving, by the data protection manager, a request to restore the at least one asset from the backup of the at least one asset;
receiving, by the data protection manager, updated telemetry from the plurality of data nodes;
using, by the data protection manager, at least the updated telemetry to determine a preferred restore data node from the plurality of data nodes; and
signaling, by the data protection manager, the preferred restore data node to perform the restoration of the at least one asset,
wherein the preferred restore data node is different than the preferred data node,
wherein the preferred restore data node is selected based on the updated telemetry indicating that it is not currently performing any backups.

19. The system of claim 17, wherein the telemetry includes a current load of each of the plurality of data nodes.

20. The system of claim 19, wherein the preferred data node is determined, at least in part, based on which of the plurality of data nodes the telemetry shows has the lowest current load.
